(19) United States
(12) Patent Application Publication
(10) Pub. No.: US 2015/0116913 A1
(43) Pub. Date: Apr. 30, 2015

(54) SYSTEM FOR SHARING POWER OF RACK MOUNT SERVER AND OPERATING METHOD THEREOF

(71) Applicant: ELECTRONICS AND TELECOMMUNICATIONS RESEARCH INSTITUTE, Daejeon (KR)

(72) Inventors: Won-Ok KWON, Daejeon (KR); Hag-Young KIM, Daejeon (KR)

(73) Assignee: ELECTRONICS AND TELECOMMUNICATIONS RESEARCH INSTITUTE, Deajeon (KR)

(21) Appl. No.: 14/292,236

(22) Filed: May 30, 2014

(30) Foreign Application Priority Data
Oct. 30, 2013 (KR) 10-2013-0130301

(51) Int. Cl. H02B 1/21

(52) U.S. Cl. CPC H02B 1/21
USPC 361/624

(57) ABSTRACT

Disclosed herein are a system for sharing power of rack mount server and an operating method thereof. The system for sharing power of a rack mount server according to the present invention comprises: a plurality of servers installed inside a rack main frame and mounted with a power sharing backplane; a rack connected to the power sharing backplane of the plurality of servers in which a power bus bar, receiving power outputted from the connected power supply units, which are mounted in a part of or all of the plurality of servers, is mounted; and a rack power controller collecting power information of the power supply units through the power bus bar mounted inside the rack and controlling operation status of the power supply units based on the collected power information.

### CROSS REFERENCE TO RELATED APPLICATION

This application claims the benefit of Korean Patent Application No. 10-2013-0130301, filed on Oct. 30, 2013, entitled “System for sharing power of rack mount server and operation method thereof”, which is hereby incorporated by reference in its entirety into this application.

### BACKGROUND OF THE INVENTION

1. Technology Field

The present invention relates to a rack mount server, particularly a system for sharing power of a rack mount server in which a power bus bar is mounted in one side of a rack and is connected to a connector of a power supply unit, which is mounted in each server to share power outputted from all power supply units, collect power information of each power supply unit, and control the operation of the power supply units based on the collected power information.

2. Description of the Related Art

A blade system, which provides data communications and power through an interconnection of a backplane, provides and monitors power efficiently through a centralized power system. The blade system has some advantages in high integration density, easy management and simple connections of networks and power cables. However, there are also disadvantages so that it has not been widely used in the market since each manufacturer has their own brand-specific configuration settings so that compatibility of devices is impossible and it is very costly.

On the other hand, a 1U, 2U low-price rack mount server has been widely used in the majority of data centers since a system may be configured with excellent performance for cost.

Generally, a rack mount server has a data storage unit in the front, a mainboard in the center and power supply units and other I/O connectors in the back.

In other words, the power supply unit provides DC output voltage which the server uses by receiving external AC power, inputs/outputs control signals such as power-on signals, power status signals, load balancing signals and the like, and provides relating signals, when a power management bus (PMBUS) is used, to a mainboard.

A product, of which a power capacity of the power supply unit is higher than rated peak load which the server uses, is used. Generally a product having higher than 20%˜30% of extra capacity is used. However, power management and monitoring may be difficult due to distributed power supply units for each server and it thus requires additional power supply unit for each server in order to provide power redundancy.

### SUMMARY OF THE INVENTION

An object of the invention is to resolve the problems associated with the conventional technologies and is thus to provide a system for sharing power of rack mount server which may share power through a bus bar by using a power sharing backplane server and connect each distributed power supply unit to the bus to monitor power status, and control power operation, and an operating method thereof.

However, the objects of the present invention are not limited to the description above and it is to be appreciated that other objects which are not described above may be understood distinctly from the description below to a person skilled in the art.

A system for sharing power of a rack mount server according to an aspect of the present invention to establish the above objects may comprise: a plurality of servers installed inside a rack main frame and mounted with a power sharing backplane; a rack connected to the power sharing backplane of the plurality of servers in which a power bus bar, receiving power outputted from the connected power supply units, which are mounted in a part of or all of the plurality of servers, is mounted; and a rack power controller collecting power information of the power supply units through the power bus bar mounted inside the rack and controlling operation status of the power supply units based on the collected power information.

Preferably, the server comprises a power supply unit; a mainboard operating by using power provided from the power supply units; and a power sharing backplane board mounted between the power supply unit and the mainboard and connected to the power bus bar to receive or provide power therethrough.

Preferably, the server operates based on the power provided from the power bus bar when the server controls to operate or stop power supply of the internal power supply unit according to control of the rack power controller.

Preferably, the server comprises: an external connector connected to the power bus bar to receive power therethrough; and a mainboard operating by using the power received through the external connector.

Preferably, the rack power controller comprises a processor collecting power information of the power supply units and controlling operation status of each of the power supply units based on the collected power information; and a network interface providing the collected power information or the operation status of the power supply units to a manager terminal.

Preferably, the rack power controller determines operation status of the power supply units based on the collected power information to be that total power capacity of the power supply units, which are determined to be operating without failure, is higher than pre-determined maximum power consumption of the rack and to let the number of the operation power supply units be the minimum.

A system for sharing power of a rack mount server according to another aspect of the present invention may comprise: a power bus bar connected to a power sharing backplane of a plurality of servers which are mounted inside the rack main frame to receive power outputted from power supply units mounted in a part of or all of the plurality of servers; and a rack power controller collecting power information of the power supply units through the power bus bar and controlling operation status of the power supply units based on the collected power information.

Preferably, when the rack power controller controls to stop the operation of power supply for a power supply unit of a certain server, the rack power controller lets the corresponding server receive power from the power bus bar and operates based on the received power.

Preferably, when the rack power controller controls to perform the operation of power supply for a power supply unit of a certain server, the rack power controller lets the corresponding server provide power to the power bus bar and shares the provided power with other servers.

Preferably, the rack power controller comprises: a processor collecting power information of the power supply units and controlling operation status of each of the power supply units based on the collected power information; a memory storing the operation status of each of the power supply units in a form of a virtual power pool; and an interface providing the collected power information or the operation status of the power supply units to a manager terminal.

Preferably, the rack power controller determines operation status of the power supply units based on the collected power information to be that total power capacity of the power supply units, which are determined to be operating without failure, is higher than pre-determined maximum power consumption of the rack and to let the number of the operation power supply units be the minimum.

A method for operating a system for sharing power of a rack mount server according to another aspect of the present invention may comprise: collecting power information of power supply units mounted in a part of or all of a plurality of servers through a power bus bar which receives power outputted from the power supply units mounted in a part of or all of the plurality of servers which are mounted inside a rack main frame; determining operation status of each of the power supply units based on the collected power information; and controlling each operation of the power supply units based on the determined operation status.

Preferably, the determining step determines operation status of the power supply units based on the collected power information to be that total power capacity of the power supply units, which are determined to be operating without failure, is higher than pre-determined maximum power consumption of the rack and to let the number of the operation power supply units be the minimum.

Preferably, when it is controlled to stop the operation of power supply for a power supply unit of a certain server, the controlling step lets the corresponding server receive power from the power bus bar and operates based on the received power.

Preferably, when it is controlled to perform the operation of power supply for a power supply unit of a certain server, the controlling step lets the corresponding server provide power to the power bus bar and shares the provided power with other servers.

The system for sharing power of a rack mount server of the present invention reduces excessive power consumption compared to the actual maximum power consumption by utilizing a power bus, which is mounted in one side of a rack and connected to a connector of a power supply unit which is mounted in each server, to share power outputted from all power supply units, collecting power information of each power supply unit, and controlling the operation of the power supply units based on the collected power information.

In addition, even though any one of the power supply units fails, power may be supplied safely since power outputted from all of the power supply units is shared through the power bus bar so that the system for sharing power of a rack mount server of the present invention may be safely operated.

### BRIEF DESCRIPTION OF THE DRAWINGS

FIG. 1 illustrates a system for sharing power of a rack mount server according to an embodiment of the present invention.

FIG. 2a and FIG. 2b illustrate detail configurations of a server according to an embodiment of the present invention.

FIG. 3 illustrates another power supply unit according to an embodiment of the present invention.

FIG. 4 illustrates detail configuration of a power bus bar according to an embodiment of the present invention.

FIG. 5 illustrates operation of a rack power controller according to an embodiment of the present invention.

FIG. 6 illustrates a method for operating a system for sharing power of a rack mount server according to an embodiment of the present invention.

### DESCRIPTION OF THE EXEMPLARY EMBODIMENTS

Hereinafter, the system for sharing power of a rack mount server and its operating method according to certain embodiments of the invention will be described below in more detail with reference to the accompanying drawings. Portions required for understanding an operation and an action according to the present invention will be described in detail.

Further, in describing components of the present invention, components having the same name may be denoted by different reference numerals in each of the drawings and be denoted by the same reference numerals in different drawings. However, even in this case, corresponding components may not have different functions in each of exemplary embodiments or may not have the same function in different exemplary embodiments, and functions of the respective components should be judged based on a description of the respective components in corresponding exemplary embodiments.

Particularly, the present invention suggests a new method for operating a system for sharing power of a rack mount server by utilizing a power bus, which is mounted in one side of a rack and connected to a connector of a power supply unit which is mounted in each server, to share power outputted from all power supply units, collecting power information of each power supply unit, and controlling the operation of the power supply units based on the collected power information.

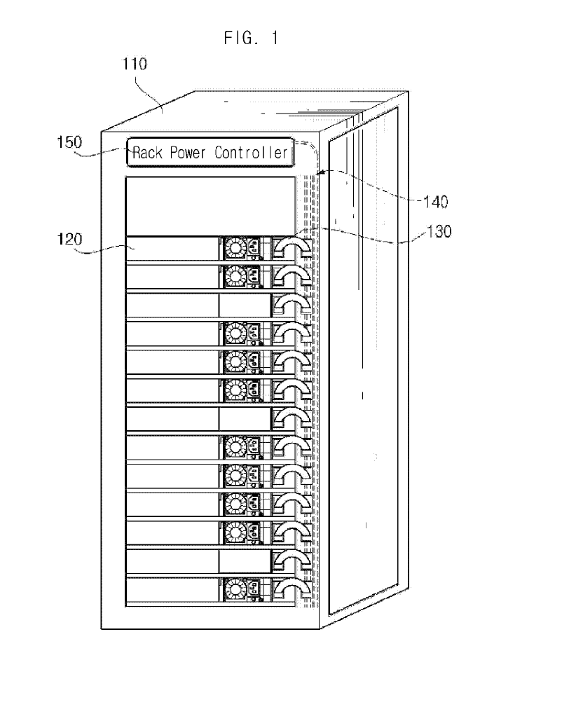

FIG. 1 illustrates a system for sharing power of a rack mount server according to an embodiment of the present invention.

As illustrated in FIG. 1, a system for sharing power of a rack mount server according to the present invention may be configured to include a rack main frame 110, a server 120, a connecting cable 130, a power bus bar 140, and a rack power controller 150.

The rack main frame 110 may include a plurality of servers 120 mounted with a power sharing backplane.

The server 120 may share power outputted from power supply units mounted in other servers 120 through the power sharing backplane.

The server 120 may or may not comprise a power supply unit therein. All servers 120 comprise the power sharing backplane to share power.

When a control signal is received from the rack power controller, the server 120 may or may not operate the power supply unit mounted inside according to the received control signal. That is, when the server 120 stops the operation of the power supply unit according to the control signal, the server may receive power outputted from power supply units mounted in other servers of the rack.

The connecting cable 130 may connect each of the plurality of servers mounted in the rack to the power bus bar.

The power bus bar 140 may let the power outputted from the power supply units mounted in the rack be shared.

The rack power controller 150 can monitor power information of the power supply units through the power bus bar 140 and control operation of the power supply units according to the monitored result.

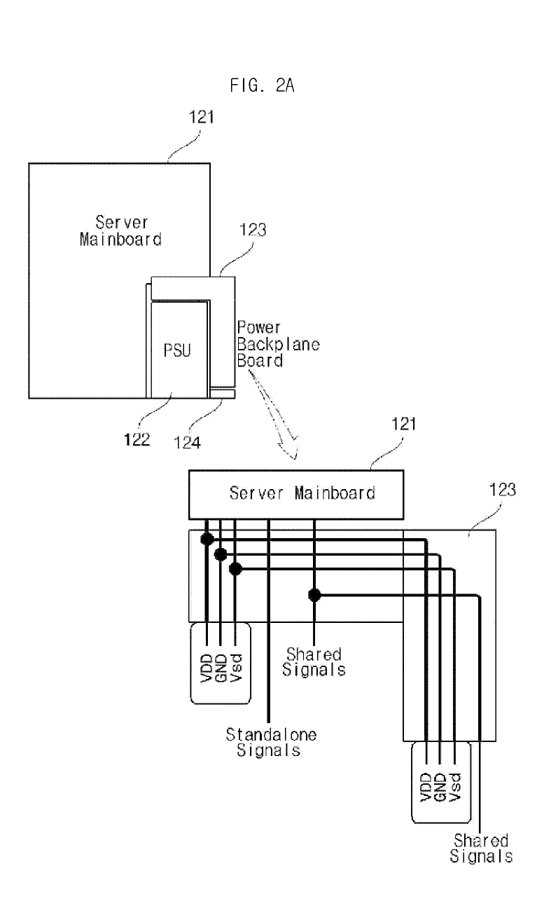

FIG. 2a and FIG. 2b illustrate detail configurations of a server according to an embodiment of the present invention.

Referring to FIG. 2a, the server 120 may be configured to include a mainboard 121, a power supply unit 122, a power backplane board 123, and an external connector 124.

The mainboard 121 is connected to a power supply unit and a connector and receives power from the connected power supply unit and thus control a plurality of devices with the received power.

The power supply unit 122 can input/output power signals, independent signals, and shared signals, etc. The power signal includes DC output power VDD, standby power Vsb, ground signals GND and the like, the independent signal includes power on PSON for power On or Off, reset RST, power status signals PSOK and the like, and the shared signal includes load shared signals of power supply units, management signals such as power management bus (PMBus).

The power backplane board 123 can be placed between the mainboard 121 and the power supply unit 122.

The external connector 124 can be connected to the connecting cable to connect to the power bus bar.

Referring to FIG. 2b which illustrates detail configuration of a server according to an embodiment of the present invention in which the power backplane board is mounted, various connectors can be provided at the back side of the mainboard 121.

A ventilation fan 122a and an AC input connector 122b can be also provided in the back side of the power supply unit 122.

An external connector 124 can include an interface to input or output DC output power VDD 124a, ground signals GND 124b, standby power Vsb 124c, and shared signals 124d, etc.

The server 120 with such configurations can extend power and shared signals to the external connector 124 through the power backplane board 123 which is inserted between the mainboard 121 and the power supply unit 122.

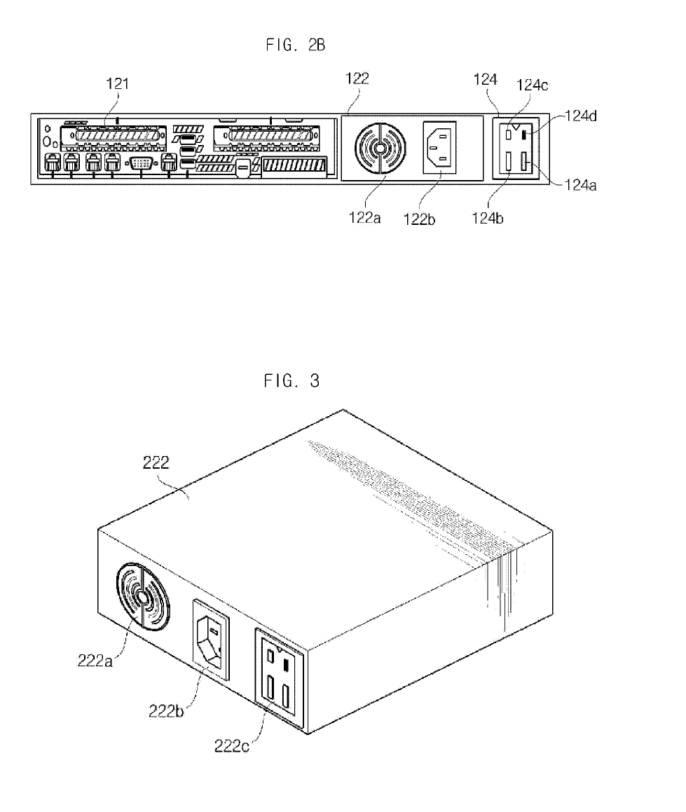

FIG. 3 illustrates another power supply unit according to an embodiment of the present invention.

Referring to FIG. 3, the power supply unit 222 can include a ventilation fan 222a, an AC input connector 222b, an external connector 222c at the back side.

The external connector 222c can include an interface such as DC output power VDD, ground signals GND, standby power Vsb, and shared signals, etc. to share power without having a power backplane board. The power supply unit can also have additional internal wires which are identical to the power backplane board to receive power by being connected to the external connector 122c.

The system of the present invention can have the external connector 122c to share power at the back side of the power supply unit 122 without additional power backplane board in the server.

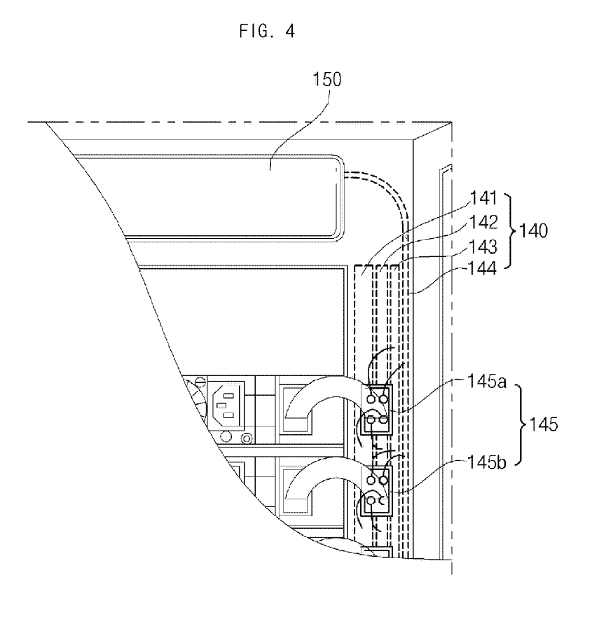

FIG. 4 illustrates detail configuration of a power bus bar according to an embodiment of the present invention.

As illustrated in FIG. 4, the power bus bar 140 according to the present invention is mounted inside the rack and can be provided in a form of bus or bus bar which has relatively small power loss.

The power bus bar 140 can be configured to include a DC output signal VDD bus bar 141, a ground signal GND bus bar 142, standby power Vsb bus bar 143, and a management bus bar 144 to connect shared signals.

A connector 145 can be provided on one side of the power bus bar 140 to connect the power bus bar 140 with the server. The connector 145 can be arranged at the most adjacent to the bus bar or the external connector of the server to minimize power loss.

The cable or connector which connects the external connector of the server and the internal connector of the rack can be manufactured enough to flow DC power and be flexible but have rigid connection.

The management bus bar 144 can be connected with a rack power controller 150 and provided inside the rack.

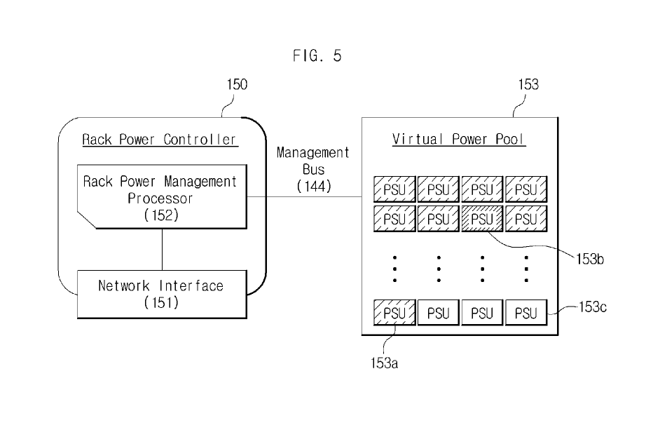

FIG. 5 illustrates operation of a rack power controller according to an embodiment of the present invention.

As illustrated in FIG. 5, the rack power controller 150 according to the present invention can manage the power supply units distributed in the rack by configuring in a form of virtual power pool.

The rack power controller 150 is connected with all of the power supply units and the management bus bar. Here, bus communication is facilitated with various standard protocols such as PMBus, I2C, RS232, USB(universal serial bus) and the like.

Monitoring channel and control channel can be operated for the management bus bar.

The rack power controller 150 can monitor power information of all power sharing units distributed in the rack through the monitoring channel. Here, the power information can include information of operation, failure, power loss, operation temperature and the like of each power supply unit.

In addition, the rack power controller 150 can transmit a control signal of performing or stopping the operation of each power supply unit through the control channel to the corresponding power supply unit.

The rack power controller 150 is configured with a network interface 151, a rack power a management processor 152 to manage status of the power supply unit 153.

The processor 152 collects and analyzes power information of each of the plurality of power supply units and controls operation of each power supply unit according to the collected and analyzed result.

The rack power management processor 152 can manage status of an operating power supply unit 153a, a failed power supply unit 153b, a stopped power supply unit 153c and the like through the management bus bar 144.

The rack power management processor 152 can provide not only the result obtained by analyzing power information of each power supply unit and working with a manager terminal through the network interface 151 but also control status of each power supply unit.

The processor 152 can manage operating power units to operate with an appropriate number of operating power units for rack power consumption so that the power supply unit can operate with the best power efficacy.

For example, 20 of power supply units having 700 W capacity are managed as a virtual power pool. If actual rack maximum power consumption is 5 kW and reserve power is 1.5 kW which is assumed to be approximately 30% of the actual rack maximum power consumption, total 6.5 kW power is required.

It means that only 10 of power supply units can apply enough power capacity so that the rest 10 of power supply units can be switched to standby state, resulting in reduction in power consumption.

The exemplary embodiments of the present invention described herein are only an example of the present invention and may be variously performed with rack power management programs by concerning reserve power and power efficiency of the system.

On the other hand, a manager terminal can receive the analyzed result and control status by accessing to the rack power controller through web, simple network management protocol (SNMP) and the like.

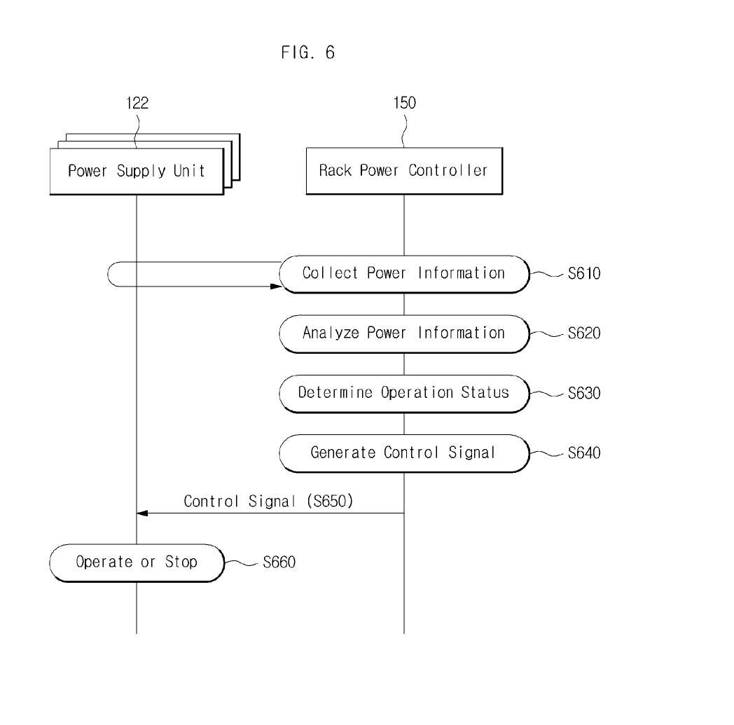

FIG. 6 illustrates a method for operating a system for sharing power according to an embodiment of the present invention.

As illustrated in FIG. 6, a rack power controller according to the present invention can collect power information of each of the plurality of power supply units through the power bus bar which is mounted inside the rack (S610).

The rack power controller analyzes the collected power information of each power supply unit (S620) and determines operation status of each power supply unit based on the analyzed result (S630).

For example, the rack power controller determines the total power capacity of the normally operating power supply units to excess the rack maximum power consumption and the number of the normally operating power supply units to be the minimum.

The rack power controller can then generate a control signal to control operation of each power supply unit according to the determined operation status (S640) and transmit the generated control signal to each power supply unit (S650).

The power supply unit receives the control signal and then performs or stops the operation for the power supply to be shared according to the received control signal through the power bus bar (S660).

Meanwhile, although it has been mentioned that all components configuring the exemplary embodiment of the present invention described hereinabove are combined with each other as one component or are combined and operated with each other as one component, the present invention is not necessarily limited to the above-mentioned exemplary embodiment. That is, all the components may also be selectively combined and operated with each other as one or more component without departing from the scope of the present invention. In addition, although each of all the components may be implemented by one independent hardware, some or all of the respective components which are selectively combined with each other may be implemented by a computer program having a program module performing some or all of functions combined with each other in one or plural hardware. In addition, the computer program as described above may be stored in computer readable media such as a universal serial bus (USB) memory, a compact disk (CD), a flash memory, or the like, and be read and executed by a computer to implement the exemplary embodiment of the present invention. An example of the computer readable media may include magnetic recording media, optical recording media, carrier wave media, and the like.

The exemplary embodiments of the present invention described hereinabove are only an example of the present invention and may be variously modified and altered by those skilled in the art to which the present invention pertains without departing from essential features of the present invention. Accordingly, the exemplary embodiments disclosed in the present invention do not limit but describe the spirit of the present invention, and the scope of the present invention is not limited by the exemplary embodiments. The scope of the present invention should be interpreted by the following claims and it should be interpreted that all spirits equivalent to the following claims fall with the scope of the present invention.

### DESCRIPTION OF REFERENCE NUMERALS

110: rack main frame
120: server
121: mainboard
122: power supply unit
123: power backplane board
124: external connector
130: connecting cable
140: power bus bar
150: rack power controller
151: interface
152: processor
153: memory

What is claimed is:

1. A system for sharing power of a rack mount server comprising:
a plurality of servers installed inside a rack main frame and mounted with a power sharing backplane;
a rack connected to the power sharing backplane of the plurality of servers in which a power bus bar, receiving power outputted from the connected power supply units, which are mounted in a part of or all of the plurality of servers, is mounted; and
a rack power controller collecting power information of the power supply units through the power bus bar mounted inside the rack and controlling operation status of the power supply units based on the collected power information.

2. The system of claim 1, wherein the server comprises:
a power supply unit;
a mainboard operating by using power provided from the power supply unit; and
a power sharing backplane board mounted between the power supply unit and the mainboard and connected to the power bus bar to receive or provide power therethrough.

3. The system of claim 1, wherein the server operates based on the power provided from the power bus bar when the server controls to operate or stop for power supply of the power supply unit according to control of the rack power controller.

4. The system of claim 1, wherein the server comprises:
an external connector connected to the power bus bar to receive power therethrough; and
a mainboard operating by using the power received through the external connector.

5. The system of claim 1, wherein the rack power controller comprises:
a processor collecting power information of the power supply units and controlling operation status of each of the power supply units based on the collected power information; and
a network interface providing the collected power information or the operation status of the power supply units to a manager terminal.

6. The system of claim 1, wherein the rack power controller determines operation status of the power supply units based on the collected power information to be that total power capacity of the power supply units, which are determined to be operating without failure, is higher than pre-determined maximum power consumption of the rack and to let the number of the operation power supply units be the minimum.

7. A system for sharing power of a rack mount server comprising:
a power bus bar connected to a power sharing backplane of a plurality of servers which are mounted inside the rack main frame to receive power outputted from power supply units mounted in a part of or all of the plurality of servers; and
a rack power controller collecting power information of the power supply units through the power bus bar and controlling operation status of the power supply units based on the collected power information.

8. The system of claim 7, wherein when the rack power controller controls to stop the operation of power supply for a power supply unit of a certain server, the rack power controller lets the corresponding server receive power from the power bus bar and operates based on the received power.

9. The system of claim 7, wherein when the rack power controller controls to perform the operation of power supply for a power supply unit of a certain server, the rack power controller lets the corresponding server provide power to the power bus bar and shares the provided power with other servers.

10. The system of claim 7, wherein the rack power controller comprises:
a processor collecting power information of the power supply units and controlling operation status of each of the power supply units based on the collected power information;
a memory storing the operation status of each of the power supply units in a form of a virtual power pool; and
an interface providing the collected power information or the operation status of the power supply units to a manager terminal.

11. The system of claim 7, wherein the rack power controller determines operation status of the power supply units based on the collected power information to be that total power capacity of the power supply units, which are determined to be operating without failure, is higher than pre-determined maximum power consumption of the rack and to let the number of the operation power supply units be the minimum.

12. A method for operating a system for sharing power of a rack mount server, the method comprising:
collecting power information of power supply units mounted in a part of or all of a plurality of servers through a power bus bar which receives power outputted from the power supply units mounted in a part of or all of the plurality of servers which are mounted inside a rack main frame;
determining operation status of each of the power supply units based on the collected power information; and
controlling each operation of the power supply units based on the determined operation status.

13. The method of claim 12, wherein the determining step determines operation status of the power supply units based on the collected power information to be that total power capacity of the power supply units, which are determined to be operating without failure, is higher than pre-determined maximum power consumption of the rack and to let the number of the operation power supply units be the minimum.

14. The method of claim 12, wherein when it is controlled to stop the operation of power supply for a power supply unit of a certain server, the controlling step lets the corresponding server receive power from the power bus bar and operates based on the received power.

15. The method of claim 12, wherein when it is controlled to perform the operation of power supply for a power supply unit of a certain server, the controlling step lets the corresponding server provide power to the power bus bar and shares the provided power with other servers.
